(19) United States
(12) Patent Application Publication
(10) Pub. No.: US 2024/0204233 A1
(43) Pub. Date: Jun. 20, 2024

(54) CYLINDRICAL BATTERY CELL, BATTERY AND METHOD FOR FORMING CYLINDRICAL BATTERY CELL

(71) Applicant: HEFEI GOTION HIGH-TECH POWER ENERGY CO., LTD., Hefei, Anhui (CN)

(72) Inventors: Azad DARBANDI, Gottingen (DE); Tobias SCHMIEG, Gottingen (DE); Qian CHENG, Hefei, Anhui (CN); Chen LI, Hefei, Anhui (CN)

(21) Appl. No.: 18/288,039

(22) PCT Filed: Jun. 28, 2021
(86) PCT No.: PCT/CN2021/102770

§ 371 Date: Oct. 24, 2023

(51) Int. Cl. H01M 10/04; H01M 50/107; H01M 50/188; H01M 50/528; H01M 50/566

(52) U.S. Cl. CPC H01M 10/0422; H01M 10/0431; H01M 50/107; H01M 50/188; H01M 50/528; H01M 50/566

(57) ABSTRACT

A cylindrical battery cell, a battery and a method for forming cylindrical battery cell are provided. In the cylindrical cell, on a bottom side of a cell housing, a copper plate is forged with the cell housing to form a bi-metal plate, and the copper plate is welded with a jellyroll structure; on an upper side of the cell housing, a cap component is configured on the jellyroll structure, and an aluminum terminal of the cap component is welded with the jellyroll structure. Therefore, the manufacturing process can be simplified and the costs consequently can be reduced; furthermore, joining/welding the cell housing with the jellyroll structure is achieved by using a laser from outside of the cell housing, while risk of corrosion of cell housing is not introduced.

### CROSS-REFERENCE TO RELATED APPLICATION

The present disclosure is a national stage application of International Patent Application No. PCT/CN2021/102770, which is filed on Jun. 28, 2021, the disclosure of which is hereby incorporated by reference in its entirety.

### TECHNICAL FIELD

Embodiments of the present disclosure generally relate to the field of battery, and more particularly, to a cylindrical battery cell, a battery and a method for forming cylindrical battery cell.

### BACKGROUND

A battery (such as an automotive battery) in general includes a plurality of battery cell. As a kind of battery cell, a cylindrical battery cell is used recently. For example, formfactors of the cylindrical battery cell may be from 2170 (diameter is 21 mm and height is 70 mm) to 50120 (diameter is 50 mm and height is 120 mm), and the cylindrical battery cell may at least include a cell housing and a jellyroll structure.

In general, the cylindrical battery cell needs to have a special current path within a cell design in order to ensure enough ampacity. Hence it is required a sophisticated current path design and special care of joints with enough ampacity. The complexity of cell structure leads normally to a complicated and costly manufacturing process, which is also susceptible to quality issues during mass production and high scrap rate.

This section introduces aspects that may facilitate a better understanding of the disclosure. Accordingly, the statements of this section are to be read in this light and are not to be understood as admissions about what is in the prior art or what is not in the prior art.

### SUMMARY

In order to solve at least part of the above problems, methods and devices are provided in the present disclosure. Features and advantages of embodiments of the present disclosure will also be understood from the following description of specific embodiments when read in conjunction with the accompanying drawings, which illustrate, by way of example, the principles of embodiments of the present disclosure.

In general, embodiments of the present disclosure provide a cylindrical battery cell, a battery and a method for forming cylindrical battery cell. It is expected to simplify the manufacturing process with less parts and/or steps and reduce the costs consequently.

In a first aspect, a cylindrical battery cell is provided. The cylindrical battery cell at least includes a cell housing and a jellyroll structure which is arranged inside the cell housing, wherein on a bottom side of the cell housing, a copper plate is forged with the cell housing to form a bi-metal plate, and the copper plate is welded with the jellyroll structure; on an upper side of the cell housing, a cap component is configured on the jellyroll structure, and an aluminum terminal of the cap component is welded with the jellyroll structure.

In some embodiments, an opening is created on the bottom side of the cell housing, the bi-metal plate being formed to seal the opening, and the copper plate is welded with the jellyroll structure by using a laser from outside of the cell housing.

In some embodiments, one or more flattened tabs of the jellyroll structure are pre-welded with a copper current collector on a bottom side of the jellyroll structure, and the copper plate is welded with the copper current collector by using a laser after the jellyroll structure is inserted into the cell housing.

In some embodiments, one or more flattened tabs of the jellyroll structure are welded with the copper plate by using a laser after the jellyroll structure is inserted into the cell housing.

In some embodiments, one or more flattened tabs of the jellyroll structure are pre-welded with an aluminum current collector on an upper side of the jellyroll structure, and the aluminum terminal is welded with the aluminum current collector by using a laser after the jellyroll structure is inserted into the cell housing.

In some embodiments, the aluminum current collector is pre-shaped and an injection hole is created on the aluminum current collector, the injection hole being through the aluminum current collector and the aluminum terminal after the aluminum terminal is welded with the aluminum current collector.

In some embodiments, the cap component is formed by using a plastic injection mold, and the cap component further comprises a cap plate and an insulation element, wherein the cap plate is arranged on the upper side of the cell housing, and the cap plate is supported by a crimped neck of the cell housing, the cap plate having a hole in which the aluminum terminal is arranged.

In some embodiments, the cylindrical battery cell further comprises: a sealing ring which is arranged on the cap plate.

In some embodiments, the cylindrical battery cell further comprises: a sealing pin which is used to seal the injection hole.

In a second aspect, a method for forming cylindrical battery cell is provided. The method includes: forging a copper plate with a cell housing to form a bi-metal plate on a bottom side of the cell housing; welding the copper plate and a jellyroll structure which is arranged inside the cell housing on the bottom side of the cell housing, and welding an aluminum terminal of a cap component and the jellyroll structure on an upper side of the cell housing.

In some embodiments, an opening is created on the bottom side of the cell housing, the bi-metal plate being formed to seal the opening, and the copper plate is welded with the jellyroll structure by using a laser from outside of the cell housing.

In some embodiments, one or more flattened tabs of the jellyroll structure are pre-welded with a copper current collector on a bottom side of the jellyroll structure, and the copper plate is welded with the copper current collector by using a laser after the jellyroll structure is inserted into the cell housing.

In some embodiments, one or more flattened tabs of the jellyroll structure are welded with the copper plate by using a laser after the jellyroll structure is inserted into the cell housing.

In some embodiments, one or more flattened tabs of the jellyroll structure are pre-welded with an aluminum current collector on an upper side of the jellyroll structure, and the aluminum terminal is welded with the aluminum current collector by using a laser after the jellyroll structure is inserted into the cell housing.

In some embodiments, the aluminum current collector is pre-shaped and an injection hole is created on the aluminum current collector, the injection hole being through the aluminum current collector and the aluminum terminal after the aluminum terminal is welded with the aluminum current collector.

In some embodiments, the method further comprises: crimping the upper side of the cell housing to form a crimped neck.

In some embodiments, the method further comprises: forming the cap component by using a plastic injection mold, wherein the cap component further comprises a cap plate and an insulation element; and arranging the cap plate on the upper side of the cell housing, wherein the cap plate is supported by the crimped neck of the cell housing, the cap plate having a hole in which the aluminum terminal is arranged.

In some embodiments, the method further comprises: inserting a sealing ring on the cap plate to seal the cell housing.

In some embodiments, the method further comprises: welding a sealing pin to seal the injection hole.

In a third aspect, a battery is provided, the battery comprises a plurality of the cylindrical battery cell according to the first aspect of the embodiments.

According to various embodiments of the present disclosure, on a bottom side of the cell housing, a copper plate is forged with the cell housing to form a bi-metal plate and the copper plate is welded with the jellyroll structure; on an upper side of the cell housing, a cap component is configured on the jellyroll structure and an aluminum terminal of the cap component is welded with the jellyroll structure.

Therefore, the manufacturing process can be simplified and the costs consequently can be reduced; furthermore, joining/welding the cell housing with the jellyroll structure is achieved by using a laser from outside of the cell housing, while risk of corrosion of cell housing is not introduced.

### BRIEF DESCRIPTION OF THE DRAWINGS

The above and other aspects, features, and benefits of various embodiments of the disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram which shows a cylindrical battery cell in accordance with an embodiment of the present disclosure;

FIG. 2 is another diagram which shows a section view of the cylindrical battery cell in accordance with an embodiment of the present disclosure;

FIG. 3 is a diagram which shows the cap component in accordance with an embodiment of the present disclosure;

FIG. 4 is a diagram which shows a method for forming cylindrical battery cell in accordance with an embodiment of the present disclosure;

FIG. 5 is another diagram which shows a method for forming cylindrical battery cell in accordance with an embodiment of the present disclosure;

FIG. 6 is a diagram which shows a cell housing forging a copper plate in accordance with an embodiment of the present disclosure;

FIG. 7 is a diagram which shows a jellyroll structure in accordance with an embodiment of the present disclosure;

FIG. 8 is another diagram which shows a jellyroll structure in accordance with an embodiment of the present disclosure;

FIG. 9 is another diagram which shows the cell housing and the jellyroll structure in accordance with an embodiment of the present disclosure;

FIG. 10 is another diagram which shows the cell housing and the jellyroll structure in accordance with an embodiment of the present disclosure;

FIG. 11 is another diagram which shows the cell housing and the jellyroll structure in accordance with an embodiment of the present disclosure;

FIG. 12 is another diagram which shows the cell housing and the jellyroll structure in accordance with an embodiment of the present disclosure;

FIG. 13 is another diagram which shows the cell housing and the jellyroll structure in accordance with an embodiment of the present disclosure.

### DETAILED DESCRIPTION

The present disclosure will now be described with reference to several example embodiments. It should be understood that these embodiments are discussed only for the purpose of enabling those skilled persons in the art to better understand and thus implement the present disclosure, rather than suggesting any limitations on the scope of the present disclosure.

It should be understood that when an element is referred to as being “connected” or “coupled” or “contacted” to another element, it may be directly connected or coupled or contacted to the other element or intervening elements may be present. In contrast, when an element is referred to as being “directly connected” or “directly coupled” or “directly contacted” to another element, there are no intervening elements present. Other words used to describe the relationship between elements should be interpreted in a like fashion (e.g., “between” versus “directly between”, “adjacent” versus “directly adjacent”, etc.).

As used herein, the terms “first” and “second” refer to different elements. The singular forms “a” and “an” are intended to include the plural forms as well, unless the context clearly indicates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof.

The term “based on” is to be read as “based at least in part on”. The term “cover” is to be read as “at least in part cover”. The term “one embodiment” and “an embodiment” are to be read as “at least one embodiment”. The term “another embodiment” is to be read as “at least one other embodiment”. Other definitions, explicit and implicit, may be included below.

In this disclosure, unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

### A First Aspect of Embodiments

A cylindrical battery cell is provided in the embodiments.

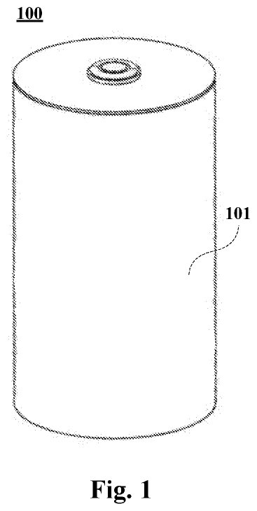

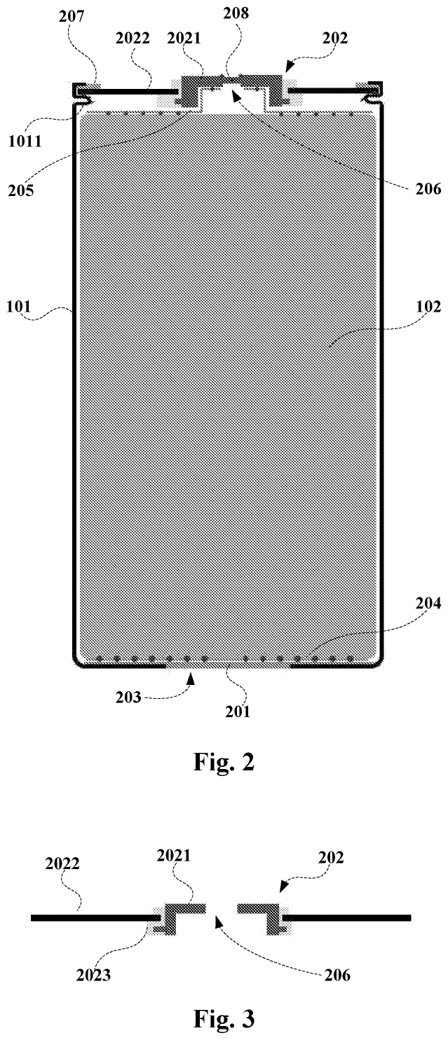

FIG. 1 is a diagram which shows a cylindrical battery cell 100 in accordance with an embodiment of the present disclosure. FIG. 2 is another diagram which shows a section view of the cylindrical battery cell 100 in accordance with an embodiment of the present disclosure.

As shown in FIG. 1 and FIG. 2, a cylindrical battery cell 100 at least includes: a cell housing 101 and a jellyroll structure 102. The jellyroll structure 102 is arranged inside the cell housing 101. For example, the jellyroll structure 102 includes a rolled anode foil, a rolled cathode foil and a rolled separator between the rolled anode foil and the rolled cathode foil. As for the detail of the jellyroll structure, please refer to relevant art.

As shown in FIG. 2, on a bottom side of the cell housing 101, a copper plate 201 is forged with the cell housing 101 to form a bi-metal plate, and the copper plate 201 is welded with the jellyroll structure 102; on an upper side of the cell housing 101, a cap component 202 is configured on the jellyroll structure 102, and an aluminum terminal 2021 of the cap component 202 is welded with the jellyroll structure 102.

In this disclosure, a laser is used to weld the copper plate 201 with the jellyroll structure 102, and/or, weld the cap component 202 with the jellyroll structure 102, but it is not limited thereto. For example, other ways such as an ultrasonic may be used in the welding process.

It should be appreciated that some components or elements are illustrated only as examples in FIG. 1 and FIG. 2. However, it is not limited thereto, for example, connections or positions of the components or elements may be adjusted, and/or, some components or elements may be omitted.

In some embodiments, an opening 203 is created on the bottom side of the cell housing 101, the bi-metal plate is formed to seal (or cover) the opening 203, and the copper plate 201 is welded with the jellyroll structure 102 by using a laser from outside of the cell housing 101. The shape/thickness of copper plate 201 can be adjusted by tooling on demand according to requirement.

Therefore, the manufacturing process can be simplified and the costs consequently can be reduced; furthermore, joining/welding the cell housing with the jellyroll structure is achieved by using a laser from outside of the cell housing, while risk of corrosion of cell housing is not introduced.

In some embodiments, one or more flattened tabs of the jellyroll structure are pre-welded with a copper current collector on a bottom side of the jellyroll structure, and the copper plate is welded with the copper current collector by using a laser after the jellyroll structure is inserted into the cell housing.

For example, as shown in FIG. 2, a copper current collector 204 is provided on the bottom side of the jellyroll structure 102. Furthermore, there are one or more flattened tabs in the jellyroll structure 102. The flattened tabs of the jellyroll structure 102 are pre-welded with the copper current collector 204 on the bottom of the jellyroll structure 102 (some dots in FIG. 2 are used to demonstrate laser welding footprints), and the copper plate 201 is welded with the copper current collector 204 by using a laser after the jellyroll structure 102 is inserted into the cell housing 101.

Therefore, the copper current collector is pre-welded to the flattened copper tabs. The cell housing (Cu) will be laser welded to the copper current collector (Cu) afterwards, such that there is no difference in melting point when welding.

In some embodiments, a thickness of the copper plate in the opening is larger than a thickness of the cell housing. For example, the copper plate 201 is forged and through the opening 203, such that the thickness (D1) of the copper plate 201 in the opening 203 is larger than the thickness (D2) of the cell housing 101, that is D1>D2.

In some embodiments, a thickness of the copper plate in the opening is equal to a thickness of the cell housing, or the thickness of the copper plate in the opening is smaller than a predetermined threshold.

For example, the copper plate 201 is forged and through the opening 203, the thickness (D1) of the copper plate 201 in the opening 203 is equal to the thickness (D2) of the cell housing 101, or the thickness (D1) of the copper plate 201 in the opening 203 is smaller than a predetermined threshold (T1); that is D1=D2, or D1<T1.

Therefore, the structure has lower thickness and enables laser welding process with lower beam intensity, which in terms enhances the quality of laser welding process and reduces manufacturing cost.

In some embodiments, one or more flattened tabs of the jellyroll structure are welded with the copper plate by using a laser after the jellyroll structure is inserted into the cell housing. For example, there is not a pre-welded copper current collector.

For example, there are one or more flattened tabs in the jellyroll structure 102. The flattened tabs of the jellyroll structure 102 are welded with the copper plate 201 by using a laser after the jellyroll structure 102 is inserted into the cell housing 101.

Therefore, the copper current collector is intendedly not considered in this example. The cell housing will be directly laser welded to the flattened copper tabs of the jellyroll structure. Consequently, one manufacturing process, welding current collector (Cu) to tabs is skipped, which reduces manufacturing costs.

In some embodiments, a thickness of the copper plate in the opening is equal to a thickness of the cell housing, or is smaller than a predetermined threshold. For example, D1=D2, and it is not limited thereto.

In some embodiments, the cell housing is made up of steel, and the bi-metal plate is formed by using a forging process on the bottom side of the cell housing. However, it is not limited thereto.

In some embodiments, on an upper side of the jellyroll structure, one or more flattened tabs of the jellyroll structure are pre-welded with an aluminum current collector, and the aluminum terminal is welded with the aluminum current collector by using a laser after the jellyroll structure is inserted into the cell housing.

In some embodiments, the aluminum current collector is pre-shaped and an injection hole is created on the aluminum current collector, the injection hole being through the aluminum current collector and the aluminum terminal after the aluminum terminal is welded with the aluminum current collector.

For example, as shown in FIG. 2, an aluminum current collector 205 is provided on the upper side of the jellyroll structure 102. The aluminum current collector 205 is pre-shaped and an injection hole 206 is created on the aluminum current collector 205.

In some embodiments, the cap component 202 is formed by using a plastic injection mold, and the cap component 202 further comprises a cap plate and an insulation element.

FIG. 3 is a diagram which shows the cap component in accordance with an embodiment of the present disclosure. As shown in FIG. 3, the cap component 202 includes the aluminum terminal 2021, a cap plate 2022 and an insulation element 2023. The cap plate 2022 having a hole in which the aluminum terminal 2021 is arranged. The insulation element 2023 is configured between the aluminum terminal 2021 and the cap plate 2022.

For example, the cap plate 2022 may be nickel plated steel plate or nickel coated steel, the aluminum terminal 2021 may be Al-Alloy material, the insulation element 2023 may be polymers which are electric insulating and chemically stable vs. electrolyte (e.g. PP, PE, PA etc.). however, it is not limited thereto.

As shown in FIG. 2, the cap plate 2022 is arranged on the upper side of the cell housing 101, and the cap plate 2022 is supported by a crimped neck 1011 of the cell housing 101.

As shown in FIG. 2, the cylindrical battery cell 100 further comprises: a sealing ring 207 which is arranged on the cap plate 2022.

As shown in FIG. 2, the cylindrical battery cell 100 further comprises: a sealing pin 208 which is used to seal the injection hole 206.

In this disclosure, a bi-metal (copper-steel) plate simplifies attachment/joining/welding of the jellyroll structure to the cell housing and enables welding process being carried out from outside of the cell housing. A plastic injection mold component in combination with the jellyroll structure enables laser welding of positive terminal from outside of the cell housing.

Therefore, the technical solution simplifies significantly the cell structure, reduces number of parts, enables a lean production process (higher quality and lower scrap rate), which in turn reduces cell manufacturing costs considerably. Furthermore, the technique solution of this disclosure can maximize a space usage at the bottom of the cell (higher volumetric filling ratio, higher energy content per cell, lower cost per cell mechanic).

In addition, the technical solution enhances substantially a thermal conduction path at the cell bottom. Concurrently, high in-plane thermal conduction of jellyroll structure (in vertical axis) is achieved, this enables implementation of bottom cooling at module/pack level.

For example, implementation of bottom cooling increases volumetric filling ratio at module/pack level by minimize 5%. Implementation of bottom cooling resolves many technical challenges in integration and reduces manufacturing costs.

It is to be understood that, the above examples or embodiments are discussed for illustration, rather than limitation. Those skilled in the art would appreciate that there may be many other embodiments or examples within the scope of the present disclosure.

It can be seen from the above embodiments, on a bottom side of the cell housing, a copper plate is forged with the cell housing to form a bi-metal plate and the copper plate is welded with the jellyroll structure; on an upper side of the cell housing, a cap component is configured on the jellyroll structure and an aluminum terminal of the cap component is welded with the jellyroll structure.

Therefore, the manufacturing process can be simplified and the costs consequently can be reduced; furthermore, joining/welding the cell housing with the jellyroll structure is achieved by using a laser from outside of the cell housing, while risk of corrosion of cell housing is not introduced.

### A Second Aspect of Embodiments

A method for forming cylindrical battery cell is provided in the embodiments. The corresponding devices are illustrated in the first aspect of embodiments, and the same contents as those in the first aspect of embodiments are omitted.

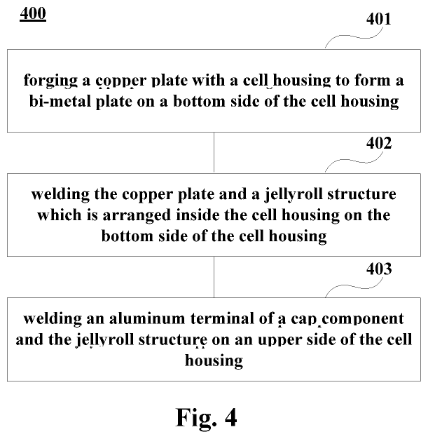

FIG. 4 is a diagram which shows a method for forming cylindrical battery cell in accordance with an embodiment of the present disclosure. As shown in FIG. 4, a method 400 for forming cylindrical battery cell includes:
401, forging a copper plate with a cell housing to form a bi-metal plate on a bottom side of the cell housing;
402, welding the copper plate and a jellyroll structure which is arranged inside the cell housing on the bottom side of the cell housing, and
403, welding an aluminum terminal of a cap component and the jellyroll structure on an upper side of the cell housing.

It should be appreciated that FIG. 4 is only an example of the disclosure, but it is not limited thereto. For example, the order of operations at blocks or steps may be adjusted, and/or, some blocks or steps may be omitted. Moreover, some blocks or steps not shown in FIG. 4 may be added.

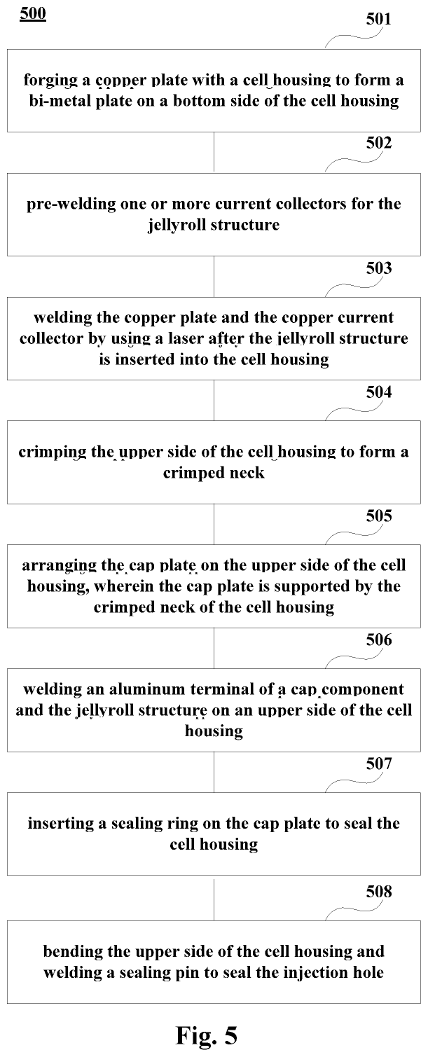

FIG. 5 is another diagram which shows a method for forming cylindrical battery cell in accordance with an embodiment of the present disclosure. As shown in FIG. 5, a method 500 for forming cylindrical battery cell includes:
501, forging a copper plate with a cell housing to form a bi-metal plate on a bottom side of the cell housing.

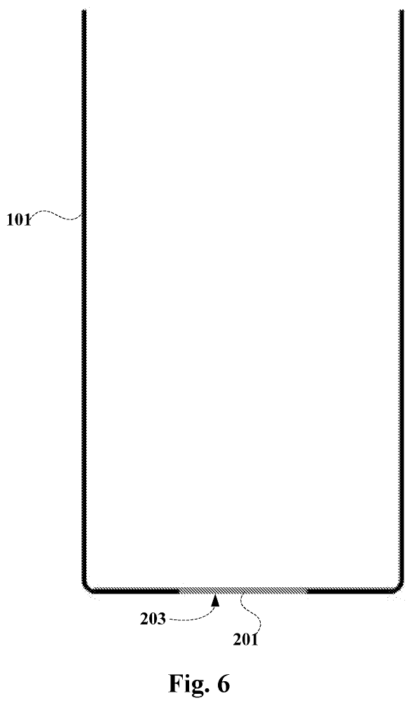

FIG. 6 is a diagram which shows a cell housing forging a copper plate in accordance with an embodiment of the present disclosure. As shown in FIG. 6, an opening 203 is created by stamping on the bottom side of the cell housing 101, the bi-metal plate being formed to seal the opening 203, and the copper plate 201 is welded with the jellyroll structure 102 by using a laser via the opening 203 from outside of the cell housing 101.

As shown in FIG. 5, the method 500 for forming cylindrical battery cell includes:
502, pre-welding one or more current collectors for the jellyroll structure.

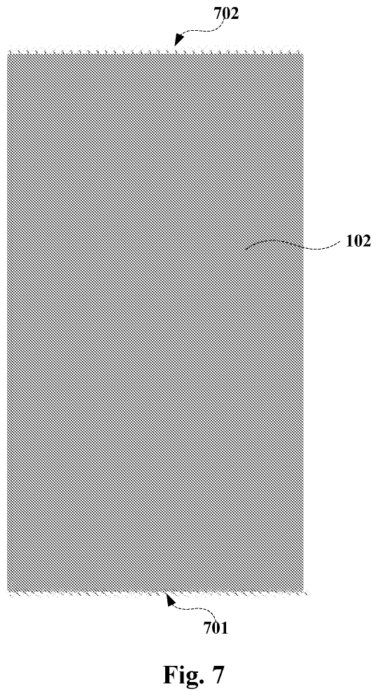

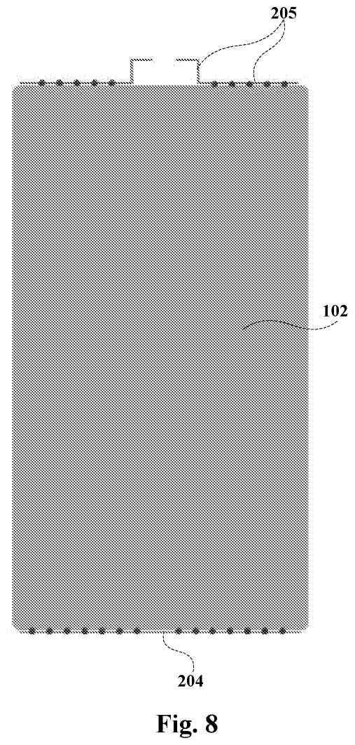

FIG. 7 is a diagram which shows a jellyroll structure in accordance with an embodiment of the present disclosure. As shown in FIG. 7, there are some flatten copper tabs 701 on the bottom side of the jellyroll structure 102, and there are some flatten aluminum tabs 702 on the upper side of the jellyroll structure 102.

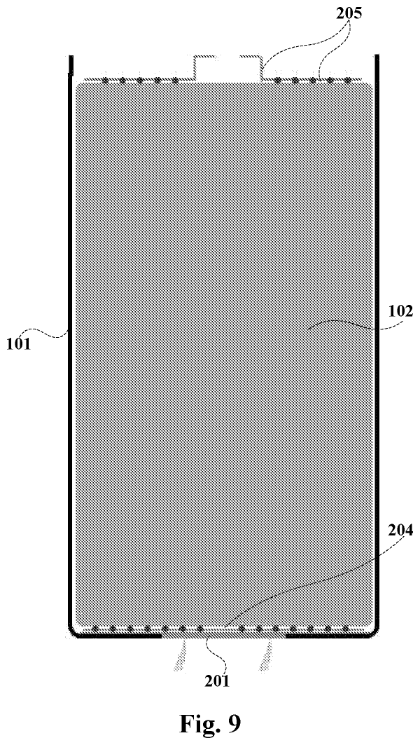

FIG. 8 is another diagram which shows a jellyroll structure in accordance with an embodiment of the present disclosure. As shown in FIG. 8, a copper current collector 204 and the flattened copper tabs 701 are pre-welded on the bottom side of the jellyroll structure 102, furthermore, an aluminum current collector 205 and the flattened aluminum tabs 702 are pre-welded on the upper side of the jellyroll structure 102.

As shown in FIG. 5, the method 500 for forming cylindrical battery cell includes:
503, welding the copper plate and the copper current collector by using a laser after the jellyroll structure is inserted into the cell housing.

FIG. 9 is another diagram which shows the cell housing and the jellyroll structure in accordance with an embodiment of the present disclosure. As shown in FIG. 9, after the jellyroll structure 102 is inserted into the cell housing 101, the copper plate 201 is welded with the copper current collector 204 by using a laser from outside of the cell housing 101.

As shown in FIG. 5, the method 500 for forming cylindrical battery cell includes:
504, crimping the upper side of the cell housing to form a crimped neck.

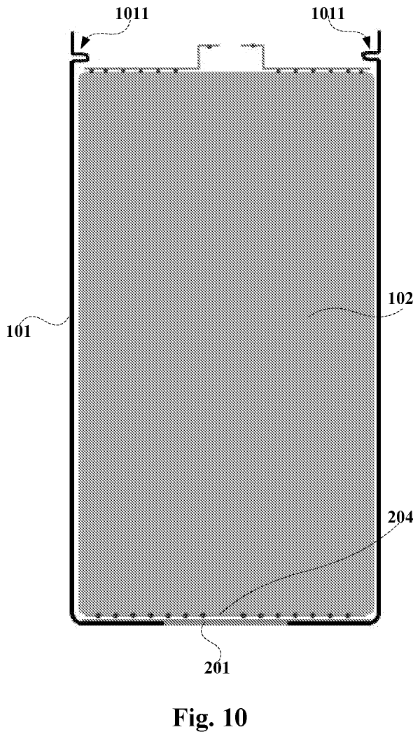

FIG. 10 is another diagram which shows the cell housing and the jellyroll structure in accordance with an embodiment of the present disclosure. As shown in FIG. 10, a crimped neck 1011 is formed by crimping the upper side of the cell housing 101.

In some embodiments, a cap component is formed by using a plastic injection mold, wherein the cap component further comprises a cap plate and an insulation element. For example, as shown in FIG. 3, the cap component 202 is formed, the cap plate 2022 have a hole in which the aluminum terminal 2021 is arranged.

As shown in FIG. 5, the method 500 for forming cylindrical battery cell includes:
505, arranging the cap plate on the upper side of the cell housing, wherein the cap plate is supported by the crimped neck of the cell housing; and
506, welding an aluminum terminal of the cap component and the jellyroll structure on an upper side of the cell housing.

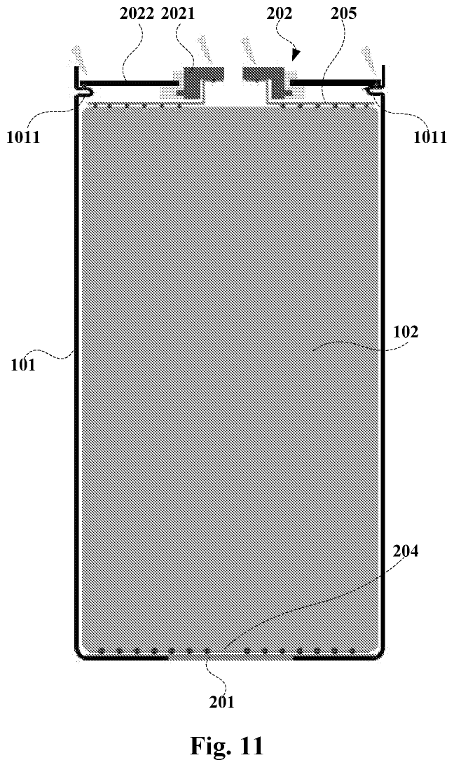

FIG. 11 is another diagram which shows the cell housing and the jellyroll structure in accordance with an embodiment of the present disclosure. As shown in FIG. 11, the cap component 202 is inserted on the upper side of the cell housing 101. The aluminum current collector 205 is weld with the aluminum terminal 2021 by using a laser from outside of the cell housing 101, furthermore, the cap plate 2022 is welded with the crimped neck 1011 by using a laser from outside of the cell housing 101.

As shown in FIG. 5, the method 500 for forming cylindrical battery cell includes:
507, inserting a sealing ring on the cap plate to seal the cell housing.

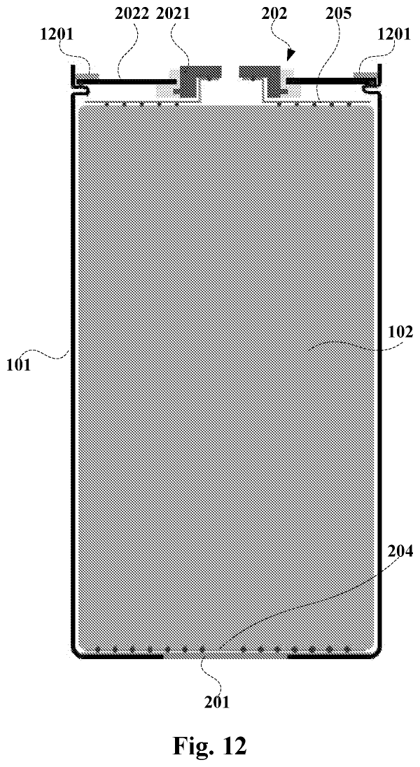

FIG. 12 is another diagram which shows the cell housing and the jellyroll structure in accordance with an embodiment of the present disclosure. As shown in FIG. 12, a sealing ring (such as O-ring) 1201 is inserted on the cap plate 2022.

As shown in FIG. 5, the method 500 for forming cylindrical battery cell includes:
508, bending the upper side of the cell housing and welding a sealing pin to seal the injection hole.

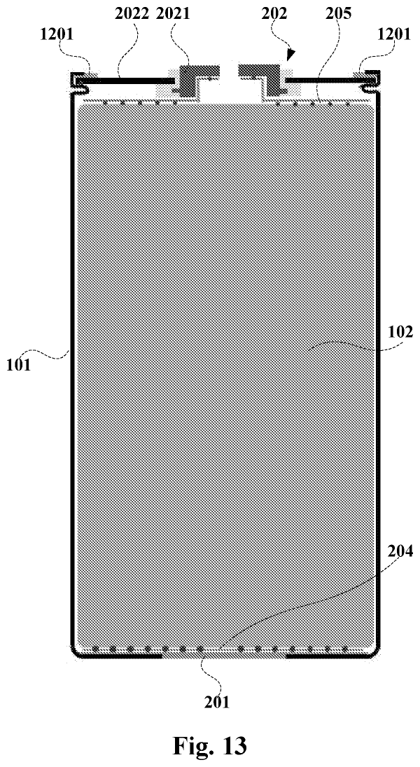

FIG. 13 is another diagram which shows the cell housing and the jellyroll structure in accordance with an embodiment of the present disclosure. As shown in FIG. 13, the upper side of the cell housing 101 is bended (crimped or closed). Afterwards, for example, as shown in FIG. 2, a sealing pin 208 is used to seal (for example by welding) the injection hole 206.

It should be appreciated that FIG. 5 is only an example of the disclosure, but it is not limited thereto. For example, the order of operations at blocks or steps may be adjusted, and/or, some blocks or steps may be omitted. Moreover, some blocks or steps not shown in FIG. 5 may be added.

Furthermore, some components or elements are illustrated only as examples in FIG. 6 to FIG. 13. However, it is not limited thereto, for example, connections or positions of the components or elements may be adjusted, and/or, some components or elements may be omitted.

It can be seen from the above embodiments, on a bottom side of the cell housing, a copper plate is forged with the cell housing to form a bi-metal plate and the copper plate is welded with the jellyroll structure; on an upper side of the cell housing, a cap component is configured on the jellyroll structure and an aluminum terminal of the cap component is welded with the jellyroll structure.

Therefore, the manufacturing process can be simplified and the costs consequently can be reduced; furthermore, joining/welding the cell housing with the jellyroll structure is achieved by using a laser from outside of the cell housing, while risk of corrosion of cell housing is not introduced.

### A Third Aspect of Embodiments

A battery is provided in the embodiments. The corresponding devices and the method are illustrated in the first and second aspects of embodiments, and the same contents as those in the first and second aspects of embodiments are omitted.

In some embodiments, the battery includes a plurality of the cylindrical battery cell according to the first aspects of embodiments.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device.

While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous.

Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A cylindrical battery cell, at least comprising a cell housing and a jellyroll structure which is arranged inside the cell housing,
wherein on a bottom side of the cell housing, a copper plate is forged with the cell housing to form a bi-metal plate, and the copper plate is welded with the jellyroll structure; on an upper side of the cell housing, a cap component is configured on the jellyroll structure, and an aluminum terminal of the cap component is welded with the jellyroll structure.

2. The cylindrical battery cell according to claim 1, wherein an opening is created on the bottom side of the cell housing, the bi-metal plate being formed to seal the opening, and the copper plate is welded with the jellyroll structure by using a laser from outside of the cell housing.

3. The cylindrical battery cell according to claim 1, wherein one or more flattened tabs of the jellyroll structure are pre-welded with a copper current collector on a bottom side of the jellyroll structure, and the copper plate is welded with the copper current collector by using a laser after the jellyroll structure is inserted into the cell housing.

4. The cylindrical battery cell according to claim 1, wherein one or more flattened tabs of the jellyroll structure are welded with the copper plate by using a laser after the jellyroll structure is inserted into the cell housing.

5. The cylindrical battery cell according to claim 1, wherein one or more flattened tabs of the jellyroll structure are pre-welded with an aluminum current collector on an upper side of the jellyroll structure, and the aluminum terminal is welded with the aluminum current collector by using a laser after the jellyroll structure is inserted into the cell housing.

6. The cylindrical battery cell according to claim 5, wherein the aluminum current collector is pre-shaped and an injection hole is created on the aluminum current collector, the injection hole being through the aluminum current collector and the aluminum terminal after the aluminum terminal is welded with the aluminum current collector.

7. The cylindrical battery cell according to claim 1, wherein the cap component is formed by using a plastic injection mold, and the cap component further comprises a cap plate and an insulation element,
wherein the cap plate is arranged on the upper side of the cell housing, and the cap plate is supported by a crimped neck of the cell housing, the cap plate having a hole in which the aluminum terminal is arranged.

8. The cylindrical battery cell according to claim 7, wherein the cylindrical battery cell further comprises:
a sealing ring which is arranged on the cap plate.

9. The cylindrical battery cell according to claim 6, wherein the cylindrical battery cell further comprises:
a sealing pin which is used to seal the injection hole.

10. A method for forming cylindrical battery cell, comprising:
forging a copper plate with a cell housing to form a bi-metal plate on a bottom side of the cell housing;
welding the copper plate and a jellyroll structure which is arranged inside the cell housing on the bottom side of the cell housing, and
welding an aluminum terminal of a cap component and the jellyroll structure on an upper side of the cell housing.

11. The method according to claim 10, wherein an opening is created on the bottom side of the cell housing, the bi-metal plate being formed to seal the opening, and the copper plate is welded with the jellyroll structure by using a laser from outside of the cell housing.

12. The method according to claim 10, wherein one or more flattened tabs of the jellyroll structure are pre-welded with a copper current collector on a bottom side of the jellyroll structure, and the copper plate is welded with the copper current collector by using a laser after the jellyroll structure is inserted into the cell housing.

13. The method according to claim 10, wherein one or more flattened tabs of the jellyroll structure are welded with the copper plate by using a laser after the jellyroll structure is inserted into the cell housing.

14. The method according to claim 10, wherein one or more flattened tabs of the jellyroll structure are pre-welded with an aluminum current collector on an upper side of the jellyroll structure, and the aluminum terminal is welded with the aluminum current collector by using a laser after the jellyroll structure is inserted into the cell housing.

15. The method according to claim 14, wherein the aluminum current collector is pre-shaped and an injection hole is created on the aluminum current collector, the injection hole being through the aluminum current collector and the aluminum terminal after the aluminum terminal is welded with the aluminum current collector.

16. The method according to claim 10, wherein the method further comprises:
crimping the upper side of the cell housing to form a crimped neck.

17. The method according to claim 16, wherein the method further comprises:
forming the cap component by using a plastic injection mold, wherein the cap component further comprises a cap plate and an insulation element; and
arranging the cap plate on the upper side of the cell housing, wherein the cap plate is supported by the crimped neck of the cell housing, the cap plate having a hole in which the aluminum terminal is arranged.

18. The method according to claim 17, wherein the method further comprises:
inserting a sealing ring on the cap plate to seal the cell housing.

19. The method according to claim 15, wherein the method further comprises:
welding a sealing pin to seal the injection hole.

20. A battery, comprising a plurality of cylindrical battery cells according to claim 9.
